(19) United States
(12) Patent Application Publication
(10) Pub. No.: US 2007/0005377 A1
(43) Pub. Date: Jan. 4, 2007

(54) Grocery depot warehouse

(75) Inventor: Richard S. Cherry, Miami, FL (US)

Correspondence Address: LOTT & FRIEDLAND, P.A., P.O. BOX 141098, CORAL GABLES, FL, 33114-1098, US

(73) Assignee: MUSKOKA, L.L.C.

(21) Appl. No.: 11/158,234

(22) Filed: Jun. 22, 2005

(51) Int. Cl. G06Q 99/00

(52) U.S. Cl. 705/1; 186/52

(57) ABSTRACT

A grocery depot warehouse used to rapidly fulfill online orders while utilizing a minimal amount of warehouse space and optimizing the grocery gathering process. The aisles of the warehouse are narrow such that a one-way traffic flow is utilized in gathering the goods, which maximizes the use of floor space. Additionally, a narrow cart, approximately 24 inches in width, is used to gather the goods comprised of a tubular frame forming two tiers connected by supporting brackes, wherein the frame holds removable totes, and has two caster wheels and two central wheels. The removable totes can be used for delivery of the goods.

### FIELD OF INVENTION

The invention relates generally to a grocery depot warehouse used to rapidly fulfill online orders while utilizing a minimal amount of warehouse space and optimizing the grocery gathering process. The aisles of the warehouse are narrow such that a one-way traffic flow is utilized in gathering the goods, which maximizes the use of floor space. Additionally, a narrow cart, approximately 24 inches in width, is used to gather the goods comprised of a tubular frame forming two tiers connected by supporting brackes, wherein the frame holds removable totes, has two caster wheels and two central wheels. The removable totes can then be used for delivery of the goods. The grocery depot warehouse is particularly suited for use by a buyer to fulfill orders for customers of an online grocery store, where the buyer receives the orders, procures the goods, and delivers the goods to the customer within approximately thirty minutes of the customer placing the online order.

### BACKGROUND OF THE INVENTION

Online grocery stores are accessible through the internet. Forecasts for online grocery sales in the United States range from $14 billion to $16 billion out of a $500 billion annual expenditure by 2005. The online grocery stores' method of doing business is continually evolving as consumers demand fresher groceries and faster delivery.

Online grocery shopping basically entails five steps for a consumer. First the consumer logs onto the online grocer's web page. Next, the consumer shops for various goods and places them in a virtual shopping cart. The consumers check out by designating the method of payment. The consumer then selects a delivery location and a delivery time.

There are many positive aspects for companies that own online grocery businesses. It is convenient for the customer. In certain business models, there is no land to rent or buy for a regular brick and mortar location that customers will visit. The only land space needed is a warehouse, which is a much more economical structure than a supermarket. Additionally, an online grocery store is open twenty-four hours a day. There are also some negative aspects for companies that own online grocery businesses. The general aspect of online shopping for groceries is not conventional. The businesses often have slim profit margins and are labor intensive. The business can expect to have complications and problems with delivery. The start up costs of the business can be very expensive. There are also minimal amounts of repeat sales.

There are many positive aspects for consumers that choose to shop at an online grocery. Shopping online saves on time. It also potentially saves the consumer money. It offers consumers a new approach to shopping. Many online stores offer the consumer a choice of delivery times and formats, so that delivery is convenient to the customer. The consumer does not have to wait in a check out line. There are also some negative aspects that a consumer may encounter when shopping online. For instance, the customer's order could be filled improperly or it could take a significant amount of time to place the order online. The delivery may not be timely or at the customer's direction. The consumer will not have the ability to pick the quality of the goods, which can be important when shopping for produce or meat. Some consumers may find that the payment options are inconvenient, for example, if an online store only accepts a credit card. There could also be a significant downside to shopping online with particular return policies and procedures. The consumer may also have to pay a significant sum for delivery of the goods.

Online grocery shopping has evolved over the years. Some online stores have revised their approach to inventory warehousing, order fulfillment, route planning, and scheduling to meet its consumers' demands. For smaller markets, some online grocery stores use affiliated stores as a warehouse and the e-grocer becomes the consumer. The shopper must pick the correct sizes, weights, degrees of freshness, and brands that the consumer would pick. This method does not assure product availability or quality and could easily defeat the purpose of online shopping. Accordingly, in larger markets, some online grocery stores use stand-alone distribution centers or warehouses. This assures the availability of the products. In such larger markets, the online grocery store can offer same day delivery within a short window of time, such as two hours.

Online grocery stores have also improved customer service by tracking customers' purchases to offer faster service or promote special sales. Online grocery stores have also begun to offer manufactured sponsor coupons and incentives tailored to individual customer's purchase behavior. The online stores also include a variety of tailored services such as: express shopping by typing in items separated by a comma the full item is automatically displayed; item comments about the quality or freshness of certain products; access to previous orders to short cut a shopping trip; sort features which are capable of sorting goods by price, nutritional content, calories, sugar content, salt content, etc.; personalized coupons tailored to the consumer; keyword search for specific products; payment options such as cash, check, credit card, debit card; delivery options and pick up options.

Even with all of the above features of online grocery shopping there is still a struggle for these online grocery stores to keep the cost of fulfillment and delivery below 18% of sales. Consumers of the online stores are demanding a faster more efficient and accurate fulfillment. However, most delivery services are not prepared to handle dry goods, refrigerated goods, frozen goods, and heated goods. Additionally, consumers are not prepared to pay more for delivery.

One of the critical problems with the current online grocery delivery methods is the use of a grocery store to fulfill orders. This method is unreliable and extremely time consuming if a quick delivery is requested. Even when a warehouse is used by an online grocery store to fulfill orders, it is not set up for optimal efficiency for receipt of goods, storage of goods, and gathering of goods for customer's orders, while retaining a low operating cost. Moreover, such warehouses typically tend to be very large structures that are expensive to maintain, while only servicing a minimal amount of territory surrounding the location.

Online purchasing clubs have been created that provide an online, interactive purchasing environment and includes consumer members, retailer members, and buyer members all located within a geographical member area. An example of such a club is www.30minutemall.com. Consumers purchase items online from retailers within the geographical area for delivery within approximately thirty minutes. Buyers receive the orders made by consumers, buy the products, deliver the products and collect payment for delivery and procurement services directly from the consumer. The purchasing club collects brokering fees and membership fees. The consumers benefit from the convenience of on-demand delivery of all products available within the geographic club area, usually in less time and always with less involvement than if the consumer were to procure the products him or herself.

An online purchasing club, as described above, can be used to purchase groceries. However, it will be difficult for a buyer to procure and deliver groceries within approximately thirty minutes when shopping at a regular grocery store or a huge warehouse. Moreover, although a large warehouse will accommodate a larger geographical club area or territory, such an increase in territory will increase the delivery time to the outer areas of the territory. Accordingly, it is desirable to have a grocery depot warehouse that is designed for the rapid fulfillment of online orders that utilizes a minimal amount of warehouse space and optimizes the grocery gathering process for a buyer. It is also desirable to have a specially designed cart for navigating such an optimized depot warehouse and which assists a buyer or assembler in efficiently gathering groceries.

### SUMMARY OF THE INVENTION

The present invention overcomes significant deficiencies in the art by providing a grocery depot warehouse and cart that are tailored to serving an online grocery store. The grocery depot warehouse is designed for optimal efficiency in a minimal amount of space for receipt of goods, storage of goods, and gathering of goods for fulfilling online orders. The grocery depot warehouse comprises a plurality of shelves for storing the goods, narrow aisles between the shelves approximately 30 inches wide, a one-way traffic flow in the aisles, and a cart for use in the narrow aisles that is approximately 24 inches wide with at least two totes for carrying the goods.

The grocery depot warehouse of the invention is used by a buyer to rapidly fulfill a customer's orders taken by an online grocery store comprising a plurality of shelves for storing grocery goods to be delivered to online customers, narrow aisles between the shelves approximately 30 inches wide, a one way traffic flow in the aisles for optimal efficiency for an assembler in gathering the goods while maximizing use of floor space for shelves. The buyer or assembler uses a special cart to gather the goods comprised a tubular frame forming two tiers connected by supporting brackes, wherein the frame holds the totes, and has two caster wheels and two central wheels. The buyer uses the grocery depot warehouse to fulfill orders for customers of the online grocery by receiving the orders, picking up the preassembled order and delivering the goods to the customer within approximately thirty minutes of the customer placing the order online.

Generally, the present invention describes a grocery depot warehouse for the rapid fulfillment of online orders that utilizes a minimal amount of warehouse space and optimizes the grocery gathering process for a buyer or assembler. The floor space of the warehouse is approximately 3,300 to 4,000 square feet. A plurality of shelves are arranged in the floor space such that the aisle between the shelves is approximately 30 inches wide. A narrow cart, about 24 inches in width, is used by the buyer or the assembler to gather goods. [0015] Accordingly, it is an object of the present invention to provide a grocery depot warehouse for optimal efficiency for receipt of goods, storage of goods, and gathering of goods for customer's online grocery orders, while retaining a low operating cost.

Another object of the present invention is to provide a grocery depot warehouse that utilizes a minimal amount of floor space to store a significant volume of groceries for purchase by a buyer, wherein the buyer is purchasing groceries pursuant to an online customer's order and the buyer is delivering the groceries to the online customer in a relatively minimal amount of time. Another object of the present invention is to provide a cart specifically designed to be used in a small grocery depot warehouse and which also is designed to save time in gathering and delivery of online ordered groceries.

These and other objects, features, and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is a grocery depot warehouse layout.

FIG. 2 is a grocery depot warehouse layout identifying the coding system to be used.

FIG. 3 is a front view of a section of shelving.

FIG. 4 is a front view of a cart.

FIG. 5 is a top view of the upper level of the cart.

FIG. 6 is a top view of the lower level of the cart.

### DETAILED DESCRIPTION

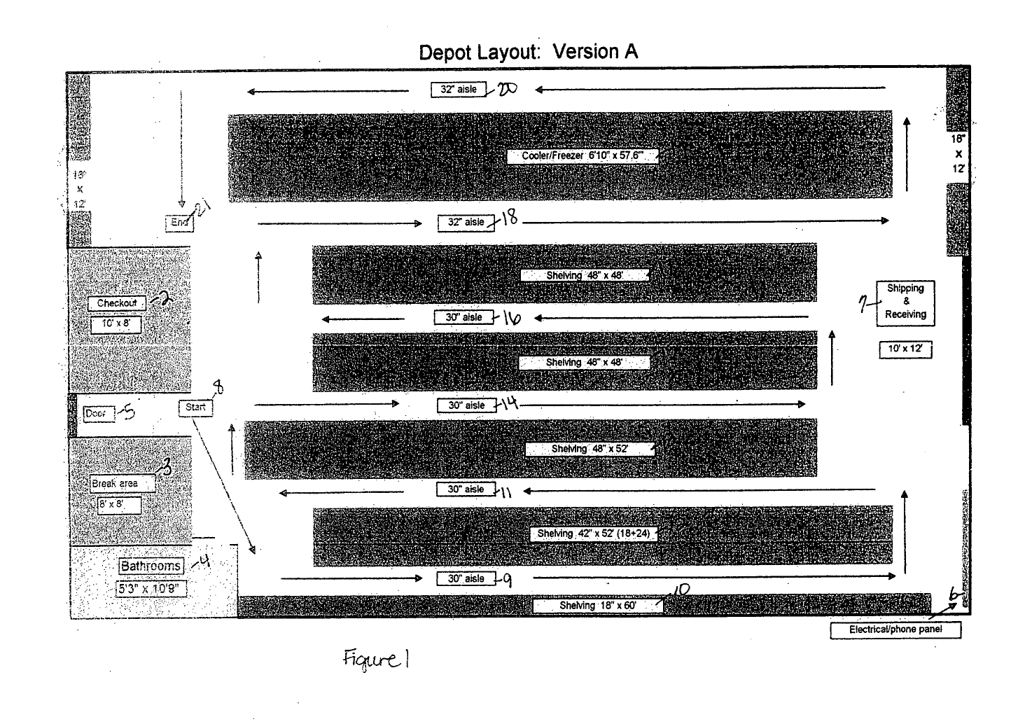

FIG. 1 is a floor plan showing a sample layout for a grocery depot warehouse 1, which is particularly suited to serving online grocery businesses. The depot warehouse 1 is designed for efficiency in rapidly fulfilling customers' online orders. The depot warehouse 1 is also designed for efficiently receiving and storing a significant volume of product, in particular grocery products, in a minimal amount of space.

The grocery depot warehouse 1 is a typical warehouse structure, which is modified to fit the needs of servicing online grocery orders. The warehouse 1 is designed to be compact and fit into a relatively small amount of space, such as approximately 4000 square feet. The use of a small space saves significantly on the warehouse 1 cost, thus reducing the overhead needed to run the depot warehouse 1 and providing greater returns for the online grocery industry. The warehouse 1 includes a checkout 2 area, a break area 3, restrooms 4, an electrical and phone panel 6, a shipping and receiving area 7, door 5 and several aisles 9, 11, 14, 16, 18, and 20 which are surrounded by shelves 10, 12, 13, 15, and 19 and a cooler/freezer 19.

The grocery depot warehouse 1 may employ a staff that is responsible for receiving orders from an online grocery store and assembling the orders. The warehouse 1 staff may be responsible for delivering the groceries to the customer or the online grocery store may be responsible for independently hiring drivers. A variety of known arrangements with delivery services are possible. Optionally, the grocery depot warehouse 1 will designate certain staff as drivers. Alternatively, the online grocery is a purchasing club that includes buyers who are associated with the online grocery and visit the grocery depot warehouse 1 to fulfill online customer's orders and deliver orders. Such buyers are independent delivery personnel who receive the online orders, purchase the online orders at the grocery depot warehouse 1, and deliver the goods to the customer. Under such an arrangement, the buyers are able to deliver the online ordered goods to the customers within approximately thirty minutes. Additionally, in such an arrangement, the grocery depot warehouse 1 can employ a staff wherein the staff member assembles the order and the buyer comes to the depot warehouse 1 to buy the assembled order and delivers it to the customer. For purposes of this application, the term buyer will be used to represent a person who fulfills orders through use of the grocery depot warehouse 1, with the understanding that this person can be employed in any of the above-described arrangements. The term assembler will be used to represent a person who receives the online order and gathers the goods for the order in the grocery depot warehouse 1. An assembler may be a buyer or a grocery depot warehouse 1 employee.

In order to effectuate a desired thirty minute delivery, the depot warehouse 1 layout must be extremely efficient for a buyer or assembler. The warehouse 1 is designed such that there is a particular traffic flow up and down the aisles. This improves the efficiency of the warehouse 1 and allows the aisles to be narrower while the shelves can be larger. As shown in FIG. 1, the aisles 9, 11, 14 and 16 are approximately 30 inches wide. The use of such narrow aisles 9, 11, 14, 16, 18 and 20 allow for additional shelving and in turn, a greater volume of groceries may be stored in a smaller amount of floor space in the warehouse 1. The use of narrow aisles 9, 11, 14, 16, 18 and 20 and a one-way traffic flow in the aisles 9, 11, 14, 16, 18 and 20 require a unique, appropriately adapted cart 25 to be used. The cart 30 is shown in FIG. 3.

Referring again to FIG. 1, a buyer or assembler starts fulfilling orders at point 8. With cart 30 a buyer or assembler heads down aisle 9 picking the appropriate groceries from one or more online customer orders from shelving 10 and shelving 12. At the end of aisle 9, the buyer or assembler turns the cart 30 and walks down aisle 11 picking the appropriate items from shelving 12 and shelving 13. At the end of the aisle 11, the buyer or assembler turns down aisle 14 and picks the designated groceries from shelving 13 and shelving 15. At the end of aisle 14, the buyer or assembler turns down aisle 16 and gathers the designated groceries from shelving 15 and 17. At the end of aisle 16, the buyer or assembler turns down aisle 18. In aisle 18, the buyer or assembler chooses groceries from shelving 17 and refrigerated or frozen groceries from cooler/freezer 19. After the buyer or assembler passes down aisle 18, the buyer or assembler can gather items from shelf 21, which is on the outer wall of the warehouse 1. The buyer or assembler then turns down aisle 20. In aisle 20, the buyer or assembler chooses the necessary refrigerated or frozen groceries from the cooler/freezer 19. After the buyer or assembler exits aisle 20, the buyer or assembler can gather items from shelf 22. At this point all of the necessary groceries have been obtained and the buyer or assembler ends the grocery gathering as designated in spot 21. The buyer or assembler then enters the check out area 2.

In the preferred embodiment of the invention and as shown in FIG. 1, the grocery depot warehouse 1 is approximately 75 feet by 45 feet or around 3500 to 4000 square feet. This is a fairly small warehouse and therefore it is critical that the layout be compact and efficient in order to store a large volume of groceries. In such a space, the shelving 10 is designed to be 18 inches deep by 60 feet long. Shelving 12 is designed to be 42 inches deep and 52 feet long. Shelving 13 is designed to be 48 inches deep and 52 feet long. Shelves 15 and 17 are designed to be 48 inches deep and 48 feet long. The cooler/freezer 19 is designed to be 57.6 inches deep and 60 feet long. Shelves 21 and 22 are 18 inches deep and 12 feet long. Aisles 9, 11, 14, and 16 are designed to be 30 inches wide. Aisles 18 and 20 are designed to be 32 inches wide.

Additional necessary areas take up minimal space in the grocery depot warehouse 1. The shipping and receiving area 7 is in the rear of the warehouse 1 and is approximately 10 feet by 12 feet. The arrangement of the shelving units allow for access from the shipping and receiving area 7 to all shelves. The check out area 2, the break area 3 and the bathrooms 4 use space in the front of the warehouse 1. The check out area 2 is approximately 10 feet by 8 feet of floor space. The break room 3 is approximately 8 feet by 8 feet. The bathrooms are 5 feet by 10.9 feet.

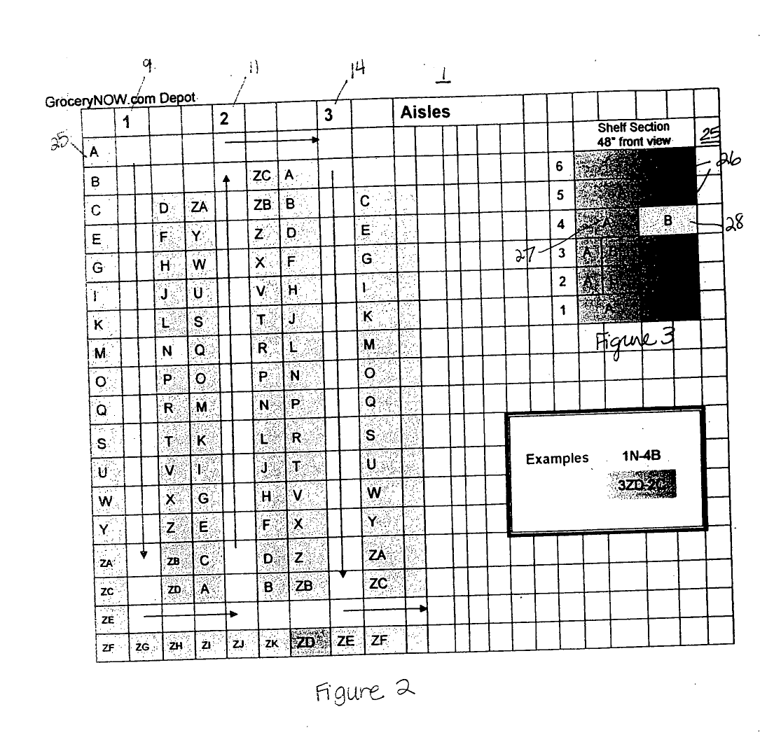

For additional efficiency in assisting a buyer or assembler to gather groceries, the depot warehouse 1 aisles utilize a coding system, as shown in FIG. 2. The coding system is used to rapidly identify the location of a particular good. The code includes 4 indicators, including two numbers and two letters in the format of “1N-4B”. Each particular number or letter can be expanded to double digits or double letters depending upon the size of the grocery depot warehouse 1. The first number represents the aisle 9, 11, and 14 number. The second letter of the code represents the aisle shelf section 25. The third number represents the actual shelf 26. The fourth letter represents the position of the product on the particular shelf 26. FIG. 2 shows a portion of the depot warehouse 1 floor plan. Shown are aisles 9, 11 and 14. The pattern of coding shown is continued through out the floor plan for ease of stocking the shelves 26 and gathering the goods.

As shown in FIG. 2, the shelving 26 in each aisle 9, 11 and 14 is divided into vertical sections 25 and each section 25 is identified by a letter of the alphabet. When the end of the alphabet is reached, an additional letter is added to the code, such that the code reads “ZA”. The combination of letters can be varied, so long as the letters are unique identifiers of the location of the section 25 in the aisle. The alphabet continues around the end of the aisle in serpentine fashion. At the beginning of the first section 25 of the second aisle 11, the alphabet is begun again starting from the letter “A”. In the second aisle the number system will begin with “2” denoting the second aisle 11. The aisle 9, 11 and 14 is the first number of the code.

As shown in FIG. 3, the sections 25 of the shelves 26 are further identified by the numbering of the individual shelves 26. The shelf 26 number identifies on which particular shelf 26 a product may be found. The section of shelving 25 shown in FIG. 3 has six shelves 26, which are identified by a number beginning from the bottom shelf 26 with number “1” and continuing to the top shelf 26, which is numbered “6”. This numbering system can be used for as many shelves 26 included in each section 25. The shelf 26 number is the third number in the code. Each particular shelf 26 is also sub-divided to indicate where on the shelf 26 a particular good may be located. As shown in FIG. 3, shelf 26, which is designated as “4” for coding purposes, shows two areas of the shelf 26. The shelf 26 coded as “4” has a left portion of the shelf 26 labeled as “A” 27 and a right portion of the shelf 26 labeled as “B” 28. This serves to further identify the location of a particular good. The particular position of the product on the shelf 26 is the fourth indicator in the code. The shelves 26 can be broken down into as many sections as needed and would directly depend upon the size of the particular goods being stored on the shelf 26.

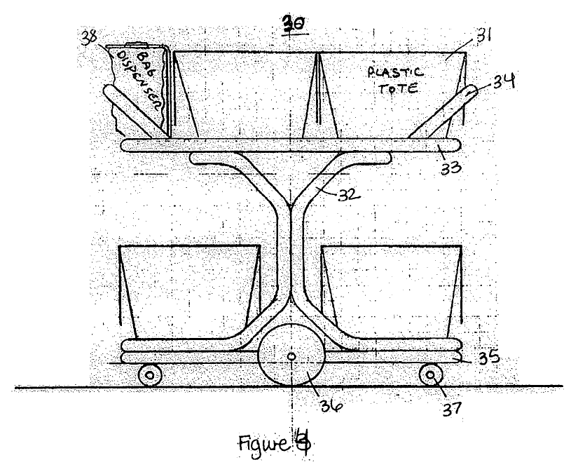

In order to efficiently navigate such a compact floor plan, special carts 30 are used. As shown in FIGS. 4, 5 and 6, the cart 30 is narrow and capable of being operated from either direction. Accordingly, when one end of the cart 30 is full, the cart 30 can be turned around and the other end can be filled. The cart 30 includes at least two levels for storing gathered goods. The goods are stored in plastic totes 31 on the cart 30. The plastic totes 31 can be removed from the cart 30, closed and used as a convenient method of delivering the online order. The plastic tote 31 prevents items from being damaged during the delivery process. The cart 30 is designed to be approximately 40 inches in height, 44 inches in length and 24 inches in width. These measurements can be varied while retaining the benefit of the design of the cart 30 and its efficiency in such a grocery depot warehouse 1. The plastic totes 31 are held in the cart 30 by a frame. The frame of the cart 30 is made up of supporting brackets 32 which are fixed to a bottom horizontal frame 35 and horizontal upper frame 33. Supporting brackets 32 are approximately 24.5 inches in height. The cart 30 may be constructed of aluminum, thin wall steel tubing or other appropriate materials.

As shown in FIG. 4, 5 and 6, two plastic totes 31, 13 inches in height and 17 inches in width, fit into the space on either side of the central supporting brackets 32. The plastic totes 31 are held stationary and in place by the bottom horizontal frame 35. There is a clearance of approximately 11.5 inches between the upper shelf and the top of the plastic totes 31 on the bottom level of the cart 30. Additional storage is provided by two more plastic totes 31 on the top level of the cart 30. Also provided on the top level of the cart 30 is room for a bag dispenser 38. The top level of the cart 30 is designed so that the plastic totes 31 slide from one end to the other a fixed distance allowing the bag dispenser 38 to be placed on either end of the cart 30. The handles 34 on either end of the cart 30 not only serve as a method of pushing the cart 30, but also hold the plastic totes 31 on the cart 30 and prevent them from falling from the cart 30.

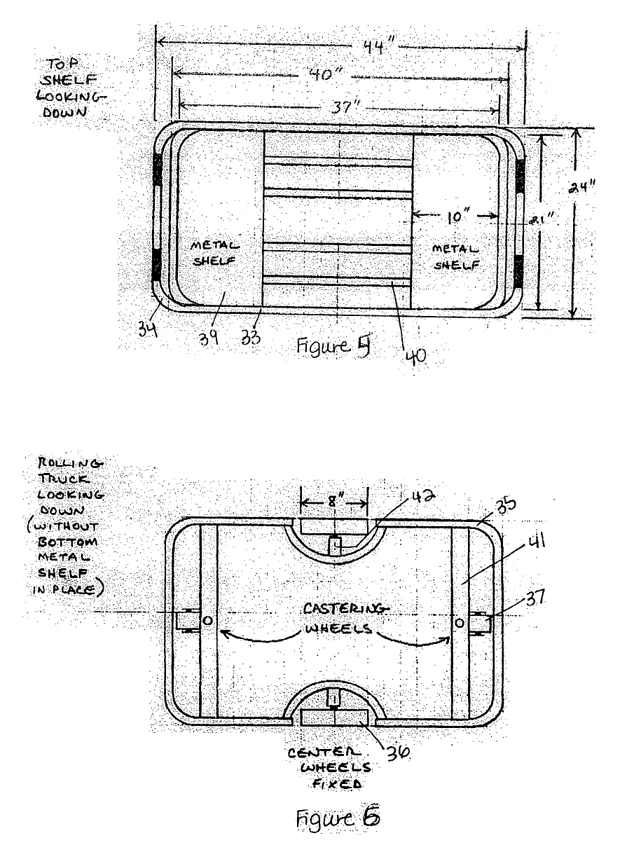

FIGS. 5 and 6 are top views of the cart 30, FIG. 5 being the top view of the upper level of the cart 30 and FIG. 6 being the top view of the lower level of the cart 30. Shown in FIG. 5 are horizontal bar members 40 upon which the bottom of the plastic totes 31 are placed. There are two metal shelves 39 on either side of the upper level of the cart 30 which provide additional support for the plastic totes 31. The metal shelves 39 are approximately 10 inches in width, with a length that extends the entire width of the cart 30, which is approximately 21 inches in the preferred embodiment.

Shown in FIG. 6 is the bottom level of the cart 30 without the bottom metal shelf in place. The bottom metal shelf is similar to the metal shelves 39 found in the upper level of the cart 30. The lower level of the cart 30 includes two wheel bar members 41, which extend the width of the cart 30 and attach to the bottom horizontal frame 35 relatively close to the ends of the cart 30. Attached to the wheel bar members 41 are caster wheels 37. The caster wheels 37 are centrally located on the wheel bar members 41. Central wheels 36 are fixed onto an axis 42. The central wheels 36 are inset in wheel wheels created in the bottom horizontal frame 35 along the side of the cart 30. The central wheels 36 are approximately 8 inches in diameter. The carts 30 large central wheels 36 and caster wheels 37 reduces the turning radius of the cart and allows for more efficient use in the depot warehouse's 1 compact space.

81 The cart 30 is ideally useful in the grocery depot warehouse 1, as it can assist the buyer or assembler with navigating the narrow aisles when providing ample storage for goods. The plastic totes 31 can be useful in separating several small orders and for gathering large orders. In the preferred embodiment, while the orders are being gathered from the shelves 26, the products are being entered into an accounting/checking device and bagged. The layout of the grocery depot warehouse 1 in combination with the unique cart 30 that enables groceries to be gathered, checked and bagged, saves an enormous amount of time in the process. This is critical when the goal is to achieve a minimal delivery time, such as thirty minutes.

The cart 30 is easily disassembled for shipping and storage. In such a disassembled state, cart 30 can be stored and/or shipped while taking up minimal space. Therefore, the cart 30 is an essential element of the grocery depot warehouse 1, due to its narrow construction and ability to be compactly stored when disassembled.

Accordingly, it will be understood that the preferred embodiment of the present invention has been disclosed by way of example and that other modifications and alterations may occur to those skilled in the art.

What is claimed is:

1. A grocery depot warehouse designed for optimal efficiency in a minimal amount of space for receipt of goods, storage of goods, and gathering of goods for fulfilling online orders comprising:
a plurality of shelves for storing said goods intended to fulfill online orders;
narrow aisles between said shelves, wherein said aisles are approximately 30 inches wide;
a one way traffic flow in said aisles; and
a cart for use in said narrow aisles, wherein said cart is approximately 24 inches wide with at least two removable totes for carrying said goods.

2. The grocery depot warehouse of claim 1 further comprising a shipping and receiving area.

3. The grocery depot warehouse of claim 1 further comprising a check out area.

4. The grocery depot warehouse of claim 1 wherein said cart is approximately 44 inches in length, has a tubular frame forming two tiers connected by supporting brackes, wherein said frame holds said totes, and has two caster wheels and two central wheels.

5. The grocery depot warehouse of claim 4 wherein said cart can be pushed from the front or the back of said cart.

6. The grocery depot warehouse of claim 1 further comprising a cooler positioned in the last of said aisles so that cold goods stay cold longer.

7. The grocery depot warehouse of claim 1 wherein a buyer uses said grocery depot warehouse to fulfill orders for customers of said online grocery store, including the steps of: said buyer receiving said orders, an assembler gathering said order for pickup by said buyer, and said buyer delivering said goods to said customer within approximately thirty minutes of said customer placing the online order.

8. The grocery depot warehouse of claim 7, wherein said removable totes of said cart are used as delivery containers by said buyer for delivery to said online customer.

9. A grocery depot warehouse used by a buyer to rapidly fulfill a customer's orders taken by an online grocery store comprising:
a plurality of shelves for storing grocery goods to be delivered to said customers;
narrow aisles between said shelves, wherein said shelves are approximately 30 inches wide;
a one way traffic flow in said aisles for optimal efficiency for an assembler in gathering said goods while maximizing use of floor space for said shelves;
a cart used to gather said goods by said assembler comprised of a tubular frame forming two tiers connected by supporting brackes;
wherein said frame holds removable totes, and has two caster wheels and two central wheels; and
wherein said buyer uses said grocery depot warehouse to fulfill orders for said customers of said online grocery store, including the steps of: said buyer receiving said orders, said assembler gathering said goods in said cart, and said buyer picking up said goods and delivering said goods to said customer within approximately thirty minutes of said customer placing said customer order online.

10. The grocery depot warehouse of claim 9 further comprising a shipping and receiving area.

11. The grocery depot warehouse of claim 9 further comprising a check out area.

12. The grocery depot warehouse of claim 9 wherein said cart can be pushed from the front or the back of the cart.

13. The grocery depot warehouse of claim 9, wherein said removable totes are used as delivery containers by said buyer for delivery to said online customer.

14. The grocery depot warehouse of claim 9 further comprising a cooler positioned in the last of said aisles so that cold goods stay cold longer.

15. A grocery depot warehouse for the rapid fulfillment of online orders that utilizes a minimal amount of warehouse space and optimizes the grocery gathering process for a buyer comprising:
a floor space of approximately 3,300 square feet to 4,500 square feet;
a plurality of shelves arranged in said floor space such that an aisle between said shelves is approximately 30 inches in width; and
a narrow cart used by an assembler to gather said goods comprised of a tubular frame forming two tiers connected by supporting brackes, wherein said frame holds removable totes, and has two caster wheels and two central wheels, wherein said cart is approximately 24 inches wide.

16. The grocery depot warehouse of claim 15 further comprising a shipping and receiving area.

17. The grocery depot warehouse of claim 15 further comprising a check out area.

18. The grocery depot warehouse of claim 15 further comprising a one-way traffic flow in said aisles.

19. The grocery depot warehouse of claim 15 wherein a buyer uses said grocery depot warehouse to fulfill orders for customers of said online grocery store, including the steps of: said buyer receiving said orders, said assembler gathering said goods, and said buyer picking up and delivering said goods to said customer within approximately thirty minutes.

20. The grocery depot warehouse of claim 15 wherein said totes of said cart are removable from said cart and usable for delivery by said buyer to said online customer.

21. The grocery depot warehouse of claim 15 wherein said cart is compactly stored by said totes being removable and said frame being easy to disassemble.

22. The grocery depot warehouse of claim 15, wherein said cart can be pushed from the front or the back of the cart.
